(19) United States
(12) Patent Application Publication
(10) Pub. No.: US 2004/0050474 A1
(43) Pub. Date: Mar. 18, 2004

(54) Device for processing a material web; method for controlling and ascertaining the position and/or the contact pressure of a sonotrode; and method for monitoring the material web moving in a processing gap

(76) Inventors: Klaus Kubik, Tonisvorst (DE); Bernhard Funger, Krefeld (DE)

Correspondence Address: KENYON & KENYON, ONE BROADWAY, NEW YORK, NY, 10004, US

(21) Appl. No.: 10/618,510

(22) Filed: Jul. 11, 2003

(30) Foreign Application Priority Data
Jul. 13, 2002 (DE) 102 31 742.9

(51) Int. Cl. B32B 31/16

(52) U.S. Cl. 156/64; 156/73.1; 156/367

(57) ABSTRACT

A device for processing a material web. The device includes a machine base member and a sonotrode supported in a housing. The housing is joined to the machine base member by at least one flexible element.

### CLAIM FOR FOREIGN PRIORITY

This application claims the benefit of foreign priority to German Patent Application No.102 31 742.9, filed on Jul. 13, 2002.

### FIELD OF THE INVENTION

The present invention relates to a device for processing a material web, and in particular to a device for processing a material web having an ultrasonic unit including a sonotrode. The invention also relates to a method for controlling and ascertaining the position and/or the contact pressure of the sonotrode, as well as a method for monitoring the material web moving in a processing gap.

### BACKGROUND

German Patent No. DE 195 26 354 C1 describes processing a material web in a device having an ultrasonic unit including a sonotrode and having a counter-tool by guiding the material web through a gap between the sonotrode and the counter-tool and processing the material web using the sonotrode. To accomplish this, the sonotrode is clamped in a holding device, and the holding device is adjustable relative to the counter-tool by a setting mechanism. To that end, the holding device is rotationally mounted at one end, and is flexibly mounted at a further opposite end using a flat spring. By deflection of this end of the holding device against the spring tension of the flat spring, the holding device is swivelled about the pivotal point provided in the other bearing, thereby influencing the position of the sonotrode.

Conventionally, the housing in which the sonotrode is supported, is itself supported on a machine base member in a manner that it is displaceable on a slide. A loading device engaging with the housing above the sonotrode is designed to move the housing together with the sonotrode up and down vertically along the mounting. For that purpose, the loading device takes the form of a piston-cylinder unit or a knuckle joint with a longitudinal adjuster engaging with it. Alternatively, instead of the slide, it is conventional to provide levers which have a hinged joint both at the machine base member and at the housing. The levers, of which two are typically provided, are arranged with distance in the longitudinal direction of the housing. Together with the housing and the machine base member, the levers form a parallelogram that determines the movements of the housing relative to the machine base member.

The conventional method of mounting using a slide or levers is disadvantageous for the precise application of a contact pressure of the sonotrode and for accurately controlling the sonotrode position. The mechanical friction, both between the slide and the guide means on which the slide rests, and in the hinged joints of the levers leads to a hysteresis characteristic between the force applied by the loading device and the resulting change in position. Thus, the force must first overcome the friction before a change in position takes place. In addition, the friction within the loading device, e.g. the friction of sealing means in the loading device, must be overcome. When working with a conventional combination of a loading device, made of a piston-cylinder unit, and a slide mounting for the housing, a force of approximately 20 N must be applied before the housing moves. However, as soon as the friction of the mounting is overcome, loading the housing with 20 N quickly leads to a large change in position. Therefore, great demands are placed on the control system which, after the mechanical friction is overcome, must prevent an overtravel resulting from the application of a great force.

It is therefore an object of the present invention to improve the mounting of a housing that supports a sonotrode on a machine base member, and to provide a method for controlling and ascertaining the position and/or contact pressure of a sonotrode, as well as a method for monitoring the material web moving in a processing gap.

### SUMMARY OF THE INVENTION

The present invention provides an arrangement which eliminates or at least reduces the friction-encumbered movements of individual bearing elements relative to each other, and instead provides a bearing which exhibits no surface friction of individual bearing elements to be moved relative to each other. According to one embodiment of the present invention, this is achieved by flexible elements. The flexible elements set a reaction force, dependent on the spring constant, against the relative movement of the housing with respect to the machine base member. However, the reaction force can be controlled better than a restoring force based on a surface friction of the bearing elements, since, as described, such a surface friction weakens suddenly and therefore places great demands on the control system.

The present invention provides a housing which for the purposes of this appliction is defined as any element capable of holding the sonotrode. Provided in the housing is a mounting in which the sonotrode is retained, preferably in the node of the sonotrode movement. Preferably a loading device, which is designed to move the entire housing and therefore the sonotrode supported in the housing, engages with the housing. In addition, the ultrasound generating unit which drives the sonotrode is preferably accommodated in the housing.

The present invention provides a machine base member which for the purposes of this appliction is defined as the machine part of a device for processing a material web relative to which the housing holding the sonotrode is moved. Preferably, this is the central member of the device on which a counter-tool, e.g. in the form of a roll, is also supported.

The present invention provides a flexible element which for the purposes of this appliction is defined as any element which is stiff enough to hold the housing unchanged in a selected position, but which is flexible enough to be deformed by the application of a force, and thereby to change the position of the housing. For example, the flexible element, according to one embodiment of the present invention, is a hard rubber block which is joined at two opposite surfaces to the machine base member and to the housing, respectively. This hard rubber block is stiff enough to retain the housing in a desired position. However, by applying a force to the housing, the hard rubber block may be provided with a shearing load which allows it to move the surface joined to the housing relative to the surface joined to the machine base member.

In one embodiment of the present invention, the flexible element is made of non-conducting material to prevent the flow of current from the housing into the machine base member. In addition, this insulation of the housing makes it possible to measure the resistance between the processing tip of the sonotrode and a metallic counter-element. It may thereby be determined whether the sonotrode is in direct contact with the counter-element, permitting a determination to be made as to whether a possible tear in the material web to be processed or a welding through the web.

Rolls, particularly rotary punching and cutting rolls, are preferably used as a counter-element provided for forming a processing gap between a surface of the counter-element and a processing tip of the sonotrode. In this way, the material web may be cut, perforated, punched, embossed, heat-treated or similarly processed.

One embodiment of the present invention provides for joining the housing to the machine base member using at least one flat spring element as a flexible element. This flat spring element is made preferably of a flat shaped article produced from a flexible material, e.g. a spring steel, or, preferably, a glass fiber material.

In one embodiment of the present invention, the housing is preferably joined to the machine base member by two flat spring elements. One flat spring element is preferably joined at one end to the upper housing, a further flat spring element is joined at the end to the lower part of the housing, and both flat spring elements are joined, in parallel alignment, to the machine base member.

The flat spring element is preferably preloaded in a normal position of the housing. The flat spring element may thereby be brought into a position in which it reacts in a desired manner to predefined forces. Thus, it may be, for example, that the loading device is suitable for applying predefined forces, which, however, may lead to an undesirably rapid, large change in the position of the housing if the spring element were not preloaded. In such a case, preloading the flat spring element assures that, because of the preloading, the reaction force is already so great that the introduction of large forces by the loading device leads only to a desired small deflection of the housing.

In one embodiment of the present invention, the device has at least two flat spring elements, preloaded by bend-loading deflection, which join the housing to the machine base member. The two flat spring elements are preloaded in such a way that one flat spring element is deflected in the opposite direction with respect to a second flat spring element. The result is that movements of the housing relieve the one flat spring element, while they further load the second flat spring element. In this way, given an identical spring-constant characteristic of the two flat spring elements, the housing may always be moved with the application of the same force.

Control of the device according to one embodiment of the present invention, is provided by an arrangement in which the device has strain gauges on the flexible element for determining the bending load and/or stretching load of the flexible element. The information about the deformation of the flexible element thus obtained may be used for determining the position of the sonotrode. It may therefore be unnecessary to use further measuring equipment, particularly distance measuring equipment like the infrared measuring devices. In particular, strain gauges are preferably positioned at two opposite surfaces of a flat spring element. By subtracting the measured values of the strain gauges, information may thereby be gained about whether the flexible element is under bending load or under stretching load.

In another embodiment of the present invention, the device has a loading device made of a piston-cylinder unit which is joined to the housing for applying a contact pressure or for adjusting the position of the sonotrode, and which has a roller diaphragm. Such a loading device is known, for example, from German Patent No. DE 198 13 121 C1, which is incorporated by reference herein. The combination of flat springs as a flexible element with a cylinder that is joined to the housing for applying a contact pressure or for adjusting the position of the sonotrode, and which has a roller diaphragm, enables a change in the position of the sonotrode to be achieved with forces of 20 mN.

The present invention, in accordance with one embodiment thereof, also provides a method for controlling the position and/or the contact pressure of a sonotrode of a device for processing a material web, the device having a machine base member, a sonotrode supported in a housing and a loading device acting directly or indirectly on the sonotrode for producing changes in position or a contact pressure of the sonotrode, where the housing is joined to the machine base member by at least one flexible element, and measuring means are furnished on the flexible element for determining the bending load of the flexible element. For instance, the method may provide for using the information, ascertained by the measuring means relating to the bending load of the flexible element for controlling the loading device. A surface expansion of the flexible element may be ascertained by the strain gauges. This information about the deformation of the surface of the flexible element may be used to reproduce the form of the flexible element. Therefore, it is also possible to determine whether the flexible element has deformed relative to the connection point with the housing. It is thus possible to determine whether the housing has moved relative to a previous position, or else relative to the machine base member.

Particularly when two flat springs are provided which join the housing to the machine base member, it may be advantageous if the deformation of each flat spring is ascertained. This enables a determination as to whether the base member has been moved along the axis of the sonotrode, or whether the longitudinal axis of the sonotrode has been tilted. Thus, given flat springs aligned in parallel, a different deformation of the flat springs may indicate that the longitudinal axis of the sonotrode has been tilted, while a parallel, identical deformation of the flat springs may indicate that the sonotrode has not been moved along its longitudinal axis relative to the longitudinal axis.

Differences in the deformation of a plurality, e.g., two, flexible elements joining the housing to the machine base member may also be used to ascertain the contact pressure a sonotrode is exerting on a moving material web. As a function of the contact pressure, the moving material web produces a moment of rotation about the contact point of the sonotrode on the material web, so that the longitudinal axis of the sonotrode is tilted.

The present invention, in accordance with one embodiment thereof, also provides a method for ascertaining the position and/or the contact pressure of a sonotrode of a device for processing a material web moving in a processing gap, the device having a machine base member, a sonotrode supported in a housing and a loading device acting directly or indirectly on the sonotrode for producing changes in position or a contact pressure of the sonotrode, where the housing is joined to the machine base member by at least one flexible element and measuring means are furnished on the flexible element for ascertaining the stretching load of the flexible element. For instance, the method may provide for using information, ascertained by the measuring means, about a different stretching load of a block-type flexible element or a different stretching load of individual, narrow, flexible elements along the longitudinal axis of the sonotrode for ascertaining the position and/or contact pressure.

For example, the non-parallel displacement of the longitudinal axis of the sonotrode may be determined by the deformation of a block-type flexible element. For this, the lower surface would be compressed, for instance, while the upper high surface is stretched. However, the tilting of the longitudinal axis of the sonotrode may also be determined based on the different stretching load of individual flexible elements. Thus, for example, when the longitudinal axis is tilted, an upper flexible element, e.g. an elongated flat spring element, is stretched further than a lower flexible element, e.g., likewise an elongated flat spring element.

### BRIEF DESCRIPTION OF THE DRAWINGS

The present invention is further explained below with reference to the following figures showing exemplary embodiments:

FIG. 1 shows a device of the present invention in a side view, in accordance with one embodiment of the present invention;

FIG. 2 shows a piston-cylinder unit having a roller diaphragm in a cut-off view, in accordance with one embodiment of the present invention;

FIG. 3 shows a further device of the present invention in a side view, in accordance with one embodiment of the present invention; and

FIG. 4 shows a third device of the present invention in a side view, in accordance with one embodiment of the present invention.

### DETAILED DESCRIPTION

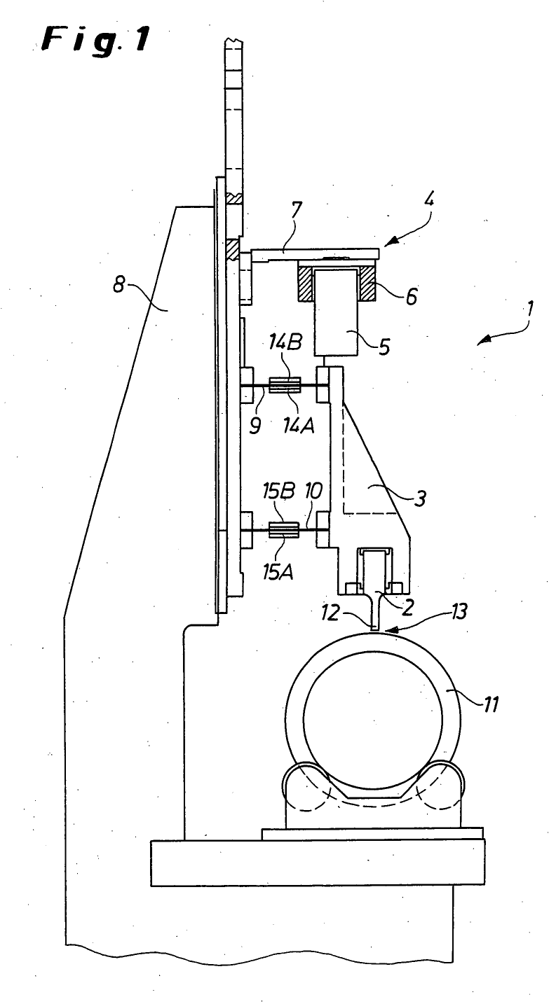

Device 1, shown in FIG. 1, for processing a material web has a sonotrode 2, a housing 3 supporting sonotrode 2 and a piston-cylinder unit 4 joined to housing 3 via a piston 5. A cylinder 6 of piston-cylinder unit 4 is fixedly joined to a machine base member 8 via a holding device 7.

Two flat spring elements 9, 10 are joined at each of their ends to housing 3 and machine base member 8, and hold housing 3 to machine base member 8.

A metallic counter-element 11, formed as a roll, is arranged so as to form a processing gap 13 between a surface of counter-element 11 and a processing tip 12 of sonotrode 2. One or more material webs to be processed may be moved through this processing gap.

For processing the material web, sonotrode 2 is excited by an ultrasonic unit (not shown). The housing 3, and sonotrode 2 supported therein, is moved relative to machine base member 8 by piston-cylinder unit 4. This movement influences the size of processing gap 13. The material web is processed differently, in particular is heat-sealed, perforated, punched, embossed or the like, depending on the size of the processing gap and the construction of the counter-element surface.

A movement of housing 3, caused by piston 5 moving in and out of cylinder 6, is opposed by the reaction force of flat springs 9, 10 placed under bending load by the movement. The magnitude of the reaction force is a function of the spring constant of the flat springs and the preloading of the flat springs. However, since no surfaces are moved relatively to each other, the magnitude of the reaction force is independent of a surface friction. Rather, the reaction force is constant, or increases or decreases uniformly, depending on the form of the flat spring. However, abrupt changes in the reaction force do not occur. Therefore, the force introduced by piston-cylinder unit 4 leads to a uniform change in position of housing 3.

Provided on both surfaces of flat-bar-shaped flat springs 9, 10 are strain gauges 14A, 14B, 15A, 15B that measure the strain of the respective surface of flat springs 9, 10. Different measured values of strain gauges 14A, 14B or 15A, 15B, allocated to a flat spring 9, 10, indicate that the flat spring was bent, thus the housing in FIG. 1 was moved upward or downward.

Equal measured values of strain gauges 14A, 14B or 15A, 15B indicate that flat spring 9 or 10 was stretched or compressed, thus flat spring 9 or 10 in FIG. 1 was moved to the right or to the left.

This information about the deformations of flat springs 9, 10 is used to ascertain the change in position of sonotrode 2. If it is determined that flat spring 9 was stretched further than flat spring 10, the longitudinal axis of sonotrode 2 may be tilted. If flat springs 9, 10 are equally deflected, thus bent, the sonotrode 2 may be moved along its longitudinal axis. The intensity of the deflection is used to determine how far sonotrode 2 was moved.

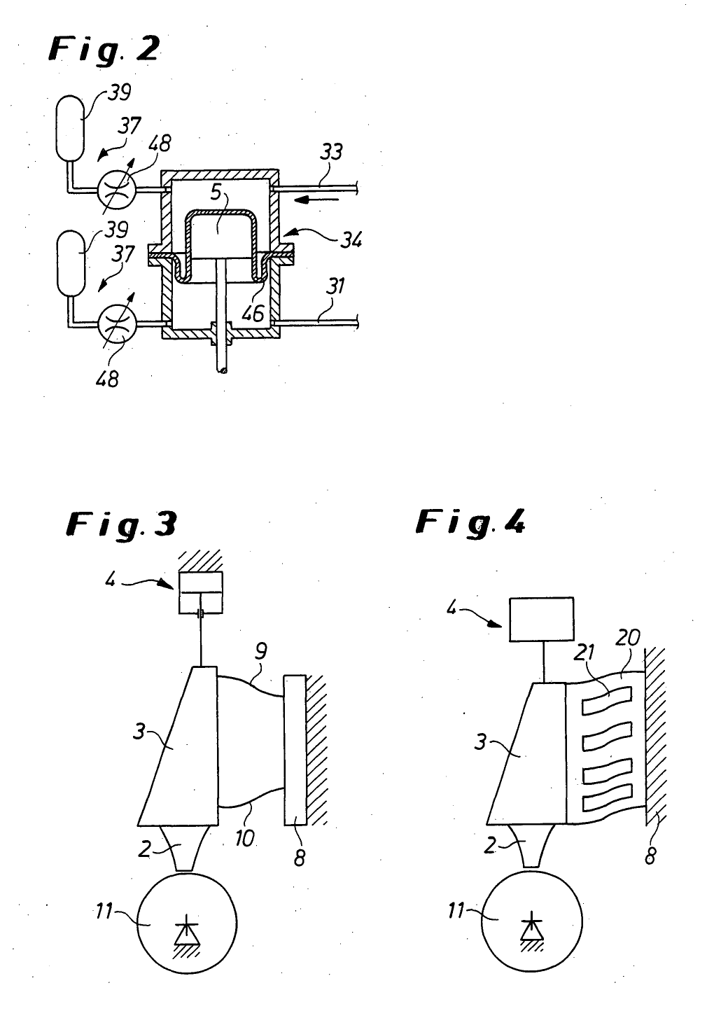

Piston-cylinder unit 4 has supply lines 31, 33 for a fluid medium used for carrying out approach motions. To avoid stick-slip effects, piston 5 of piston-cylinder unit 4 may be sealed via a roller diaphragm 46, as shown schematically in FIG. 2. In addition, piston-cylinder unit 4 may be assigned damping elements 37, each having a choke 48 and a pressure reservoir 39, to prevent axially parallel vibrations from developing due to impacts with sonotrode 2.

Retaining the same reference numerals for the same elements, FIG. 3 shows another embodiment of the device according to the present invention. In contrast to that shown in FIG. 1, in this specific embodiment, flat springs 9, 10 are deflected in opposite directions. The result is that movements of the housing relieve the one flat spring, while they further load the second flat spring. In this way, if the spring-constant characteristic of the two flat springs is the same, the housing may always be moved with the application of the same force.

Retaining the same reference numerals for the same elements, FIG. 4 shows a further embodiment of the device according to the present invention. Instead of the flat springs shown in FIGS. 1 and 3, the device shown in FIG. 4 has a single flexible element 20. It is block-like and, in addition, has hollow spaces 21 for lowering the flexural rigidity.

What is claimed is:

1. A device for processing a material web, comprising:
a machine base member; and
a sonotrode supported in a housing,
wherein the housing is joined to the machine base member by at least one flexible element.

2. The device as recited in claim 1, wherein the flexible element is made of a non-conducting material.

3. The device as recited in claim 2, further comprising a metallic counter-element which is positioned to form a processing gap between a surface of the counter-element and a processing end of the sonotrode.

4. The device as recited in claim 1, wherein the housing is joined to the machine base member by at least one flat spring element.

5. The device as recited in claim 4, wherein the flat spring element is preloaded in a normal position of the housing.

6. The device as recited in claim 4, wherein at least two flat spring elements, preloaded by bend-loading deflection, join the housing to the machine base member, and one flat spring element is deflected in the opposite direction with respect to a second flat spring element.

7. The device as recited in claim 1, wherein at least one strain gauge is mounted on the flexible element for ascertaining at least one of a bending load and a stretching load of the flexible element.

8. The device as recited in claim 7, wherein strain gauges are arranged on two opposite surfaces of a flat spring element.

9. The device as recited in claim 1, further comprising a piston-cylinder unit that is joined to the housing for applying a contact pressure or for adjusting the position of the sonotrode, and which has a roller diaphragm.

10. A method for controlling at least one of a position and a contact pressure of a sonotrode of a device for processing a material web, the device having a machine base member, a sonotrode supported in a housing and a loading device acting one of directly and indirectly on the sonotrode for producing changes in one of a position and a contact pressure of the sonotrode, where the housing is joined to the machine base member by at least one flexible element, and measuring means are provided on the flexible element for ascertaining the bending load of the flexible element, the method comprising the steps of:
ascertaining information, by the measuring means, about the bending load of the flexible element; and
using said information for controlling the loading device.

11. A method for ascertaining at least one of a position and a contact pressure of a sonotrode of a device for processing a material web moving in a processing gap, the device having a machine base member, a sonotrode supported in a housing and a loading device acting one of directly and indirectly on the sonotrode for producing changes in one of a position and a contact pressure of the sonotrode, where the housing is joined to the machine base member by at least one flexible element, and measuring means are provided on the flexible element for ascertaining the stretching load of the flexible element, the method comprising the steps of:
ascertaining, by the measuring means, information about one of a different stretching load of a block-type flexible element and a different stretching load of individual flexible elements along the longitudinal axis of the sonotrode; and
using said information for ascertaining at least one of the position and the contact pressure.

12. A method for monitoring the treatment of a material web moving in a processing gap of a device having a machine base member, a sonotrode supported in a housing and a metallic counter-element that is positioned to form the processing gap between a surface of the counter-element and a processing tip of the sonotrode, where the housing is joined to the machine base member by at least one non-conducting flexible element, the method comprising the step of meauring the electrical resistance between the sonotrode and the counter-element.
